(19) United States
(12) Patent Application Publication
(10) Pub. No.: US 2008/0001124 A1
(43) Pub. Date: Jan. 3, 2008

(54) Fluorescent composition and fluorescence conversion substrate using the same

(75) Inventors: Satoshi Hachiya, Sodegaura-shi (JP); Mitsuru Eida, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/488,672

(22) Filed: Jul. 19, 2006

(30) Foreign Application Priority Data
Jun. 29, 2006 (JP) 2006-179675

(51) Int. Cl. C09K 11/02; C09D 11/00; B32B 19/00

(52) U.S. Cl. 252/301.36; 428/690; 523/160

(57) ABSTRACT

A composition including (A) a fluorescent inorganic nanocrystal, (B) a polyfunctional cross-linkable compound, and (C) a polymerizable compound containing a group selected from a substituted or unsubstituted alkyl group having 4 to 20 carbon atoms, a substituted or unsubstituted alkylene group having 4 to 20 carbon atoms, a substituted or unsubstituted aryl group having 6 to 20 carbon atoms, or a substituted or unsubstituted arylene group having 6 to 20 carbon atoms.

### BACKGROUND OF THE INVENTION

1. Field of the Invention

The invention relates to a composition containing a fluorescent inorganic nanocrystal, in particular, to a fluorescent ink composition suitable for forming a fluorescent layer (fluorescence conversion film) on a substrate by an inkjet method or a nozzle jet method.

2. Description of Related Art

A technology is known by which light emitted from an emitting device such as an organic electroluminescent (EL) device is converted to light with a different wavelength using a fluorescence conversion layer to generate light of the three primary colors (blue, green, and red) for use in full-color displays.

The fluorescence conversion layer is formed on a substrate by a known method, such as photolithography or printing. Studies have been made on the use of fluorescent inorganic nanocrystals as a fluorescence conversion material.

However, a method for preparing a fluorescence conversion film or a fluorescence conversion substrate by an inkjet method using ink containing a fluorescent inorganic nanocrystal as the fluorescence conversion material has not yet been completely developed.

Specifically, various compositions containing fluorescent inorganic nanocrystals have been reported. However, a fluorescent layer (fluorescence conversion film) with a desired thickness is difficult to obtain using these compositions due to the presence of a large amount of solvent which causes a large difference in thickness between a wet film and a dry film.

In particular, when such a composition is used as ink for an inkjet method or a nozzle jet method, repeated applications are required to obtain a fluorescent layer with a desired thickness, which results in significantly poor productivity.

In addition, it is difficult to obtain a fluorescent layer (fluorescence conversion film) in which fluorescent inorganic nanocrystals are dispersed at a high concentration.

Patent Document 1 discloses a technology of forming a fluorescence conversion film by an inkjet method using a composition containing an organic fluorescent pigment.

However, organic fluorescent pigments are not sufficiently resistant to irradiation with light.

If fluorescent inorganic nanocrystals are used instead of the organic fluorescent dyes, in order to ensure sufficient fluorescence conversion performance, the fluorescent inorganic nanocrystals are required to be dispersed at a concentration higher than the concentration of organic fluorescent pigments. However, it is difficult to stably disperse the fluorescent inorganic nanocrystals at such a high concentration.

Patent Document 2 discloses a photopolymerizable resin composition for use in manufacturing a photoelectronic device using a nonlinear optical material, comprising a fluorescent inorganic nanocrystal, a solvent, and a polymerizable monomer.

When forming a thick fluorescence conversion film on a substrate by an inkjet method using this composition as ink, the thickness of the formed film is significantly reduced after drying due to the presence of a large amount of solvent in the ink. Therefore, the composition has to be applied to the substrate repeatedly, which leads to significantly low productivity.

Patent Documents 3 and 4 disclose an ink which is based on an aqueous medium and contains a fluorescent inorganic nanocrystal. This ink is for use in printing on paper or OHP films by an inkjet method.

Since this ink is based on an aqueous medium, this ink has the following disadvantage. When used to form a film with a thickness in the order of microns such as a fluorescence conversion film, water tends to remain in the formed film. Therefore, a film formed using this ink may not be incorporated in an electronic device.

### [Patent Document 1] JP-A-2003-229260

### [Patent Document 2] JP-A-10-186426

### [Patent Document 3] JP-A-2000-119575

### [Patent Document 4] JP-A-2004-149765

An object of the invention is to provide a composition which can be employed for forming, by a printing method, a fluorescence conversion film containing a fluorescent inorganic nanocrystal at a concentration enough to exhibit sufficient fluorescence conversion performance, in particular, to provide a composition which attains high productivity when used as ink for inkjet printing.

Another object of the invention is to provide a method for producing a fluorescence conversion substrate using the composition.

Still another object of the invention is to provide a fluorescence conversion substrate and an emitting apparatus using the composition.

### SUMMARY OF THE INVENTION

According to the invention, the following composition and the like are provided.

1. A composition comprising:

(A) a fluorescent inorganic nanocrystal;

(B) a polyfunctional cross-linkable compound; and

(C) a polymerizable compound containing a group selected from a substituted or unsubstituted alkyl group having 4 to 20 carbon atoms, a substituted or unsubstituted alkylene group having 4 to 20 carbon atoms, a substituted or unsubstituted aryl group having 6 to 20 carbon atoms, or a substituted or unsubstituted arylene group having 6 to 20 carbon atoms.

### 2. The composition according to 1, wherein the total amount of the components (A) to (C) accounts for 40 wt % or more of the composition.

### 3. The composition according to 1 or 2, wherein the component (A) is contained in an amount of 1 to 45 wt %, the component (B) is contained in an amount of 1 to 40 wt %, and the component (C) is contained in an amount of 1 to 40 wt %.

### 4. The composition according to any of 1, 2, and 3, wherein the polyfunctional cross-linkable compound (B) comprises at least one of a polyfunctional (meth)acrylate compound and a polyfunctional epoxy compound.

### 5. The composition according to any of 1 to 4, further comprising (D) a surface treatment agent for the fluorescent inorganic nanocrystal.

### 6. The composition according to 5, wherein a part or all of the surface treatment agent (D) for the fluorescent inorganic nanocrystal contains a polymerizable or cross-linkable substituent.

### 7. The composition according to 5 or 6, wherein the surface treatment agent (D) is contained in an amount of 20 wt % or less.

8. The composition according to any of 5 to 7, wherein the surface treatment agent (D) for the fluorescent inorganic nanocrystal contains at least one substituent selected from an amino group, a thiol group, a phosphoric ester group, a phosphonic acid group, a carboxyl group, an olefin group, a phosphine group, a phosphine oxide group, and an epoxy group.

### 9. The composition according to any of 1 to 8, further comprising a polymerization initiator.

### 10. The composition according to any of 1 to 9, having a content of a component with a boiling point of 200° C. or less of 0 to 60 wt %.

### 11. The composition according to any of 1 to 10, having a viscosity at 25° C. within the range of 0.001 to 0.020 Pa·s.

### 12. A cured product obtained by curing the composition according to any of 1 to 11.

13. A fluorescence conversion substrate comprising:

a substrate; and

a fluorescence conversion film formed of the cured product according to 12 and provided on the substrate.

### 14. The fluorescence conversion substrate according to 13, wherein partition walls are provided on the substrate, and the fluorescence conversion film is provided in an area partitioned by the partition walls.

### 15. A method for producing a fluorescence conversion substrate, comprising curing the composition according to any of 1 to 11 on a substrate to form a fluorescence conversion film.

### 16. The method for producing a fluorescence conversion substrate according to 15, wherein the composition according to any of 1 to 11 is applied to the substrate by a printing method, thereby forming the fluorescence conversion film.

### 17. The method for producing a fluorescence conversion substrate according to 16, wherein the printing method is an inkjet method or a nozzle jet method.

### 18. The method for producing a fluorescence conversion substrate according to any of 15 to 17, wherein the composition is applied to an area partitioned by partition walls, thereby forming the fluorescence conversion film.

19. An emitting apparatus comprising:

an emitting device; and

the fluorescence conversion substrate according to 13 or 14.

The invention can provide a composition which can be employed for forming a fluorescence conversion film containing a fluorescent inorganic nanocrystal at a concentration sufficient to provide adequate fluorescence conversion performance by a printing method. In particular, the invention can provide a composition which attains high productivity when used as ink for inkjet printing.

According to the invention, a method for producing a fluorescence conversion substrate using the composition can be provided.

According to the invention, a fluorescence conversion substrate and an emitting apparatus produced using the composition can be provided.

### BRIEF DESCRIPTION OF THE DRAWING

FIG. 1 is a view showing an emitting apparatus produced in Example 3.

In the figure, 23 denotes an organic EL device.

### BEST MODE FOR CARRYING OUT THE INVENTION

The composition of the invention comprises (A) a fluorescent inorganic nanocrystal, (B) a polyfunctional cross-linkable compound, and (C) a polymerizable compound containing a group selected from a substituted or unsubstituted alkyl group having 4 to 20 carbon atoms, a substituted or unsubstituted alkylene group having 4 to 20 carbon atoms, a substituted or unsubstituted aryl group having 6 to 20 carbon atoms, and a substituted or unsubstituted arylene group having 6 to 20 carbon atoms.

Examples of the fluorescent inorganic nanocrystal (component (A)) are given below.

(i) Fluorescent Semiconductor Nanocrystals

Group II-VI compound semiconductor nanocrystals such as ZnSe, ZnTe, and CdSe, Group III-V compound semiconductor nanocrystals such as InP, and chalcopyrite-type semiconductor nanocrystals such as CuInS₂ and CuInSe₂.

The semiconductor nanocrystals are prepared by decreasing the diameter of semiconductor crystals to the order of nanometers. Preferably, the semiconductor nanocrystals have a particle diameter of 20 nm or less, and more preferably 10 nm or less.

(ii) Fluorescent Nanocrystals Obtained by Doping Metal Chalcogenide with Transition Metal Ion

Fluorescent nanocrystals obtained by doping a metal chalcogenide such as ZnS, ZnSe, CdS, and CdSe with a transition metal ion such as Eu²⁺, Eu³⁺, Ce³⁺, Tb³⁺, and Cu²⁺.

(iii) Fluorescent Nanocrystals Obtained by Doping Metal Oxide with Transition Metal Ion.

Fluorescent nanocrystals obtained by doping a metal oxide such as Y₂O₃, Gd₂O₃, ZnO, Y₃Al₅O₁₂, and Zn₂SiO₄ with a transition metal ion such as Eu²⁺, Eu³⁺, Ce³⁺, and Tb³⁺, which absorbs visible rays.

The fluorescent nanocrystals described in (i) and (ii) above may be subjected to surface modification with a metal oxide such as silica or an organic substance such as a long-chain alkyl group or phosphoric acid to avoid oxidation of the surfaces of the nanocrystals and removal of S, Se, or the like.

Nanoparticles of which the surfaces are covered with another semiconductor called a shell are preferable in respect of stability and fluorescence. The surface of the shell may further be coated with a metal oxide such as silica or titania.

The above fluorescent inorganic nanocrystals may be employed either individually or in combination of two or more.

As the polyfunctional curable compound (B), a compound of which the cured product transmits light may be employed. Preferred examples of the compound include polyfunctional (meth)acrylate compounds, polyfunctional epoxy compounds, and trialkoxysilane. Polyfunctional (meth)acrylate compounds and polyfunctional epoxy compounds are more preferable.

Specific examples of the polyfunctional (meth)acrylate compounds include pentaerythritol triacrylate, pentaerythritol tetraacrylate, trimethylolpropane triacrylate, dipentaerythritol pentaacrylate, neopentyl glycol dimethacrylate, and 2-methacryloyloxymethyloctyl methacrylate.

Specific examples of the polyfunctional epoxy compounds include 1,7-octadiene diepoxide, diglycidyl-1,2-cyclohexane carboxylate, neopentyl glycol diglycidyl ether, triglycidyl isocyanurate, and commercially available epoxy resins (e.g. ECN, EPICLON produced by Dainippon Ink and Chemicals, Inc., and EPON produced by Japan Epoxy Resins Co., Ltd.).

Specific examples of the trialkoxysilane include hexyltrimethoxysilane, ethyltriethoxysilane, dodecyltriethoxysilane, and benzyltriethoxysilane.

The above polyfunctional curable compounds may be used either individually or in combination of two or more.

As the polymerizable compound (component (C)), a compound of which the polymer transmits light may be employed. Various known polymerizable compounds may be used. It is preferable to employ a polymerizable compound which contains a polymerizable group which is copolymerizable with the polyfunctional curable compound (component (B)).

Specifically, preferred examples of the polymerizale compounds include (metha)acrylate compounds, styrene derivatives, and vinylester compounds that contain an addition-polymerizable double bond in its molecule, epoxy compounds, oxetane compounds, and oxazole compounds that contain a ring-opening polymerizable cyclic group in its molecule, and dialkoxysilane compounds containing a condensation polymerizable group in its molecule.

Of these, (meth)acrylate compounds, styrene derivatives, vinyl ester compounds, epoxy compounds, and dialkoxysilane compounds are particularly preferable.

It is preferred that the polymerizable compound contain one addition-polymerizable double bond, ring-opening polymerizable cyclic group, or dialkoxysilyl group in its molecule.

To improve the dispersibility of the fluorescent inorganic nanocrystals, it is preferred that the compound contain a substituent selected from an alkyl group having 4 to 20 carbon atoms, an alkylene group having 4 to 20 carbon atoms, an aryl group having 6 to 20 carbon atoms, or an arylene group having 6 to 20 carbon atoms.

Specific examples of the (meth)acrylate compound include 2-ethylhexyl acrylate, dodecyl acrylate, and benzyl methacrylate.

Specific examples of the styrene derivative include styrene, 4-methylstyrene, 4-vinylbiphenyl, and methyl 4-vinyl benzoate.

Specific examples of the epoxy compound include benzyl glycidyl ether, styrene oxide, 1,2-epoxydecane, and glycidyl 4-tert-butyl benzoate.

Specific examples of the dialkoxysilane compound include dimethoxyhexylmethylsilane and diethoxydodecylmethylsilane.

Specific examples of the vinyl ester compound include vinyl hexanoate and vinyl benzoate.

The above polymerizable compounds may be employed either individually or in combination of two or more.

In the composition of the invention, the total amount of the components (A) to (C) accounts for 40 wt % or more, preferably 60 wt % or more, and more preferably 70 wt % or more of the composition.

Preferred amounts of the components (A), (B) and (C) in the composition are as follows.

The amount of the component (A) is 1 to 45 wt %, and more preferably 10 to 45 wt %.

The amount of the component (B) is 1 to 40 wt %, and more preferably 20 to 40 wt %.

The amount of the component (C) is 1 to 40 wt %, and more preferably 10 to 30 wt %.

The composition of the invention preferably contains a surface treatment agent (component (D)). By the addition of the surface treatment agent, the fluorescent inorganic nanocrystals can be dispersed in the composition more stably. As the surface treatment agent, known surface treatment agents may be employed. It is preferable to select a surface treatment agent which does not cause the polyfunctional curable compound to be cured during storage of the composition.

When the polyfunctional curable compound is a polyfunctional (meth)acrylate compound, the surface treatment agent preferably contains an amino group, a thiol group, a phosphoric ester group, a phosphonic acid group, a phosphinic group, a phosphine oxide group, a carboxyl group, or an olefin group. It is more preferred that the surface treatment agent contain a thiol group, a phosphoric ester group, a phosphonic acid group, a carboxyl group, or an olefin group. Particularly preferably, the surface treatment agent includes a thiol group, a phosphoric ester group, or an olefin group.

When the polyfunctional curable compound is a polyfunctional epoxy compound, it is preferred that the surface treatment agent contain a phosphinic group, a phosphine oxide group, an olefin group, or an epoxy group.

Specific examples of the compound containing an amino group include amino-terminated PEG, octylamine, decylamine, and glycine tert-butyl ester.

Specific examples of the compound containing a thiol group include octanethiol, octylthioglycolate, 2-ethylhexyl 3-mercaptopropionate, thiol-terminated PEG, 3-mercaptopropyltrimethoxysilane, and 3-mercaptopropyl(dimethoxy)methylsilane.

Specific examples of the compound containing a phosphoric ester group include dibutyl phosphate, di-n-decyl phosphate, di(polyethylene glycol 4-nonylphenyl) phosphate, and tributyl phosphate.

Specific examples of the compound containing a carboxyl group include decanoic acid, 2-ethylhexanoic acid, 4-hexylbenzoic acid, and 4-vinylbenzoic acid.

Specific examples of the compound containing a phosphonic acid group include octylphosphonic acid, tetradecanephosphonic acid, and diethyl benzylphosphonate.

Specific examples of the compound containing a phosphinic group include tributylphosphine and trioctylphosphine.

Specific examples of the compound containing a phosphine oxide group include tributylphosphine oxide and trioctylphosphine oxide.

Specific examples of the compound containing an olefin group include dodecene, methyl undecenoate, vinyl undecenoate, and 1,2-epoxy-9-decene.

Specific examples of the compound containing an epoxy group include 1,2-epoxy-dodecane, 1,2-epoxy-9-decene, styrene oxide, α-pinene oxide, and 3-glycidyloxytrimethoxysilane.

A part or all of the surface treatment agent (D) preferably contains a polymerizable or cross-linkable substituent. Due to the presence of such a substituent, nanocrystals are secured firmly to the cured product, whereby the dispersion stability of the nanocrystals in the film can be improved.

It is preferred that the polymerizable or cross-linkable substituent be a polymerizable group or a cross-linkable group which is copolymerizable with the polyfunctional curable compound (B). Examples of such a substituent include a (meth)acrylate group, a styryl group, a vinyl ester group, an epoxy group, a dialkoxysilyl group, and a trialkoxysilyl group.

A preferred amount of the component (D) is 20 wt % or less, and more preferably 2 to 10 wt %.

The composition of the invention preferably contains a polymerization initiator in order to improve productivity by increasing the curing speed.

For example, when the polyfunctional curable compound (B) is a polyfunctional (meth)acrylate, a photopolymerization initiator or a thermal polymerization initiator may be added.

When the polyfunctional curable compound (B) is a polyfunctional epoxy compound, a compound which generates an acid or alkali upon heating or irradiation of light may be added as the polymerization initiator.

In order to minimize a reduction in the film thickness after curing, it is preferred that the composition of the invention contain a small amount of volatile component. Therefore, the content of components with a boiling point of 200° C. or less is preferably 0 to 60 wt %.

When using the composition as ink for the inkjet method, the viscosity of the composition of the invention at 25° C. is preferably 0.001 to 0.020 Pa·s. The method for measuring the viscosity is described in the examples.

In order to maintain the strength of the fluorescence conversion film, the composition of the invention contains the polyfunctional curable compound (B).

Generally, many polyfunctional curable compound have a high viscosity since they contain a large number of polar groups such as an acrylic group or an epoxy group. Therefore, in order to adjust the viscosity of the solution to a preferable range, it is required to add a medium which serves to adjust viscosity.

In the case of typical inkjet ink, the viscosity of the solution is generally adjusted by adding a solvent.

However, the addition of a solvent is disadvantageous for the following reasons. The addition of a solvent reduces the thickness of a film formed by single application of the composition. If an attempt is made to incorporate the fluorescent inorganic nanocrystal in an amount enough to attain sufficient fluorescence conversion performance, the concentration of the nanocrystal becomes too high. As a result, the strength of the fluorescence conversion film may be decreased, or the fluorescent inorganic nanocrystals may undergo aggregation and separation.

A composition with a low concentration of the fluorescent inorganic nanocrystal must be applied a number of times in order to maintain the strength of the fluorescence conversion film, which results in low productivity.

In order to increase the dispersibility of the fluorescent inorganic nanocrystals for the polyfunctional curable compound containing a large number of polar groups such as an acrylic group or an epoxy group, it is preferable to treat the surfaces of the fluorescent inorganic nanocrystals with a substance with a high polarity.

However, if such a surface treatment is conducted, the polarity of the fluorescence conversion film becomes high, resulting in increased water absorption. The fluorescence conversion film with an increased water absorption is not suited for combined use with an electrically conductive device such as an organic EL device or a light-emitting diode (LED). Further, the fluorescent inorganic nanocrystal itself may change in properties due to water.

Therefore, in the invention, the component (C) is selected as the viscosity adjusting medium which increases the dispersibility of the fluorescent inorganic nanocrystals, is nonvolatile (a sufficient film thickness can be obtained by single application), and has not too a high polarity (water absorption is low).

The component (C) employed in the invention contains a group (hydrocarbon group) selected from an alkyl group having 4 to 20 carbon atoms, an alkylene group having 4 to 20 carbon atoms, an aryl group having 6 to 20 carbon atoms, and an arylene group having 6 to 20 carbon atoms.

Since the component (C) is a polymerizable compound, separation from the fluorescence conversion film and formation of sticky film surface can be readily suppressed.

It is preferred that the boiling point of the component (C) be 200° C. or more to attain nonvolatility.

To adjust the viscosity of the composition, a resin or a solvent may be added to the composition of the invention insofar as the film strength and the productivity are not impaired. For example, a resin such as polybenzyl methacrylate, polymethyl methacrylate, polystyrene, or silicone-modified polycarbonate, or a solvent such as xylene, diglyme, or cyclohexanone may be added.

The composition of the invention may be dried and/or cured to obtain a cured product. For example, when the composition contains a photoinitiator, the composition is cured by irradiation of active rays. When the composition contains a thermal polymerization initiator, the composition is cured by heating.

A fluorescence conversion substrate may be prepared by forming a fluorescence conversion film on a substrate using the cured product of the composition of the invention. There are no restrictions on the thickness of the fluorescence conversion film. Normally, the thickness is 1 to 100 μm. As the substrate, a plate of glass or a polymer may be employed. By providing partition walls on the substrate, and providing the composition (ink) to the areas partitioned by the partition walls to form fluorescence conversion films, several types of ink can be readily applied selectively.

The composition of the invention is cured after applying on the substrate. Application of the composition on the substrate by a printing method is preferable since a fluorescence conversion film can be formed only in the required area, which contributes to the effective use of raw materials. As the printing method, an inkjet method or a nozzle jet method may be employed.

When forming fluorescence conversion films in the areas partitioned by the partition walls, the composition may be applied to the corresponding areas to form fluorescence conversion films.

A fluorescence conversion film prepared using the composition of the invention can exhibit sufficient fluorescence conversion performance due to the high concentration of fluorescent inorganic nanocrystal. Since the composition of the invention can be employed as ink for inkjet printing, the productivity of the fluorescence conversion film and the fluorescence conversion substrate is improved.

Further, an emitting apparatus can be prepared by combining an emitting device and the fluorescence conversion substrate. As the emitting device, an emitting device which emits visible rays may be used. For example, an organic EL device, inorganic EL device, semiconductor light-emitting diode, and vacuum fluorescent display may be used. Of these, an organic EL device and an inorganic EL device are preferable. In particular, an organic EL device is preferable as the emitting device since a high luminance can be obtained at a low voltage.

### EXAMPLES

### Synthesis Example 1

### [Synthesis of InP/ZnS Nanoparticle]

With reference to J. Am. Chem. Soc., 2005, 127, 11364, an InP/ZnS nanoparticle was synthesized. The procedures are given below.

### (1) Synthesis of InP Core

0.29 g of indium acetate, 0.69 g of myristic acid, and 40 ml of octadecene were weighed in a four-necked flask with a capacity of 200 ml. The flask was then installed in a mantle heater. A mechanical stirrer provided with a glass-made stirring bar and a Teflon®-made stirring blade was secured to the main tube of the flask. A three-way stopcock was secured to one of the branched tubes, and the flask was connected to a nitrogen line and a vacuum line. A rubber-made septum cap was secured to another branched tube. A thermocouple was secured to the remaining branched tube.

After evacuating the flask, stirring was performed at 120° C. for 2 hours. The pressure was increased to atmospheric pressure using nitrogen gas, and the temperature was raised to 280° C.

In a nitrogen-replaced glove box, 1.4 g of a 10% hexane solution of tris(trimethyl)silylphosphine and 1 ml of octadecene were weighed in a sample bottle, and the resulting mixture was extracted using a gas-tight syringe.

The phosphine compound solution was injected in all at once through the septum cap of the four-necked flask. After 5 seconds, 40 ml of octadecene was added, and the reaction temperature was lowered quickly to 180° C. Stirring was performed at 180° C. for 2 hours.

Then, the temperature was lowered to 50° C., and the pressure was reduced for one hour by means of a vacuum pump.

The pressure was increased to atmospheric pressure using nitrogen gas. After decreasing the temperature to room temperature, the reaction solution was taken out. The solution was then subjected to centrifugation (3,000 rpm, 10 minutes) to remove precipitates. The supernatant liquid was temporarily stored in the glove box.

### (2) Synthesis of InP/ZnS Core/Shell Nanoparticle

1.48 g of zinc laurate, 0.11 g of sulfur, and 10 ml of octadecene were weighed in a four-necked flask with a capacity of 200 ml. The flask was provided with the same equipment as used in (1) above.

After evacuating the flask, stirring was performed at 80° C. for 30 minutes. The pressure was increased to atmospheric pressure using nitrogen gas. The solution of the InP nanoparticle which had been stored in the glove box was added. Stirring was continued at 80° C. for 1.5 hours under reduced pressure.

The pressure was then increased to atmospheric pressure using nitrogen gas, and the temperature was raised to 140° C. Stirring was continued for 1.5 hours.

The temperature was lowered to room temperature, and the reaction solution was taken out. Large particles and unreacted raw materials were removed by subjecting the solution to centrifugation (3,000 rpm, 15 minutes).

The resulting nanoparticle showed a fluorescence peak wavelength of 634 nm and a fluorescence quantum yield of 17%. The peak wavelength and the quantum yield were measured using a quantum yield measurement apparatus produced by Hamamatsu Photonics K.K. (Model C9920-02).

### Synthesis Example 2

### [Synthesis of Cu-doped ZnSe Nanoparticle]

With reference J. Am. Chem. Soc., 2005, 127, 17586, Cu-doped ZnSe nanoparticle was synthesized. The procedures are given below.

0.20 g of zinc laurate and 50 ml of octadecene were weighed in a four-neck flask with a capacity of 200 ml. The flask was provided with the same equipment as used in the synthesis Example 1.

After evacuating the flask, stirring was performed at 120° C. for 2 hours. The pressure was increased to atmospheric pressure using nitrogen gas, and the temperature was raised to 300° C.

In a nitrogen-replaced glove box, 0.02 g of selenium, 0.5 g of hexadecylamine, and 7 g of tributylphosphine were weighed in a sample bottle, and the selenium was dissolved.

The resulting selenium solution was injected in all at once through the septum cap of the four-necked flask. Stirring was continued at 290° C. for 1.5 hours.

In a nitrogen-replaced glove box, 0.031 g of copper acetate and 10 ml of tributylphosphine were weighed in a sample bottle, and the copper acetate was dissolved. 0.1 ml of the resulting solution was extracted using a syringe, and injected into the reaction solution.

After 10 minutes, a solution containing 0.1 g of zinc acetate and 5 ml of tributylphosphine was added dropwise to the reaction solution. The addition was completed in 30 minutes.

After the addition, the reaction temperature was raised to 230° C., and stirring was continued for 1.5 hours.

The temperature was lowered to room temperature, and the reaction solution was removed. The solution was subjected to centrifugation (3,000 rpm, 10 minutes) to remove precipitates. The supernatant liquid was temporarily stored in the glove box.

The resulting nanoparticle showed a fluorescence peak wavelength of 528 nm and a fluorescence quantum yield of 13%.

### Example 1

An octadecene solution of the InP/ZnS nanoparticle obtained in Synthesis Example 1 was poured into ethanol to reprecipitate the nanoparticle. After removing the solvent by decantation, the solution was vacuum-dried to obtain 140 mg of nanoparticle (component (A)).

Under a nitrogen atmosphere, 34 mg of dibutyl phosphate (component (D)) and 70 mg of 2-ethylhexyl acrylate (component (C)) were added to disperse nanoparticles. After the addition of 104 mg of trimethylolpropane triacrylate (component (B)) and 14 mg of polybenzyl methacrylate (weight average molecular weight of 15,000), the mixture was subjected to ultrasonic dispersion. Finally, 2 mg of Irgacure 907 (produced by Ciba Specialty Chemicals Inc.) was dissolved in a dark place to obtain an ink composition.

The viscosity of the resulting ink composition at 25° C. was 0.012 Pa·s, as measured with a microviscometer (AMVn, produced by Anton Parr GmbH.).

By photolithography, black matrices, each having a width of 20 μm and a thickness of 1.5 μm (V259BK, produced by Nippon Steel Chemical Co., Ltd.), were formed on a grass substrate at an interval of 90 μm. A partition wall having a width of 15 μm and a height of 10 μm (VPA100/P54-2, produced by Nippon Steel Chemical Co., Ltd.) was formed on each of the black matrices.

The ink composition was applied to the grass substrate in the area partitioned by the partition walls once, and cured by irradiation with UV rays with a wavelength of 365 nm at 300 mJ, thereby forming a fluorescence conversion substrate.

A blue organic EL device was stacked on the resulting fluorescence conversion substrate, and was caused to emit light. The blue light emitted from the organic EL device was converted to red light with a peak wavelength of 634 nm.

### Example 2

An octadecene solution of the Cu-doped ZnSe nanoparticle obtained in Synthesis Example 2 was poured into ethanol to reprecipitate the nanoparticle. After removing the solvent by decantation, the solution was vacuum-dried to obtain 103 mg of Cu-doped ZnSe nanoparticle (component (A)).

Under a nitrogen atmosphere, 20 mg of xylene and 25 mg of trioctylphosphine oxide (component (D)) were added, and the nanoparticles were dispersed. 80 mg of an epoxy resin (component (B)) (EPON825, produced by Japan Epoxy Resins Co., Ltd.), 60 mg of benzyl glycidyl ether ((component (C)) and 2 mg of tris(1-propoxyethyl)trimellitate were added, and the mixture was subjected to ultrasonic dispersion.

The viscosity was measured in the same manner as in Example 1. It was found that the ink composition had a viscosity of 0.011 Pa·s at 25° C.

The ink composition was applied once in the same manner as in Example 1. After evaporating xylene, the composition was heated to 160° C. to cause the epoxy compound to react and cure, thereby obtaining a fluorescence conversion substrate.

A blue organic EL device was stacked on the resulting glass substrate, and caused to emit light. The blue light emitted from the organic EL device was converted to green light with a peak wavelength of 528 nm.

### Example 3

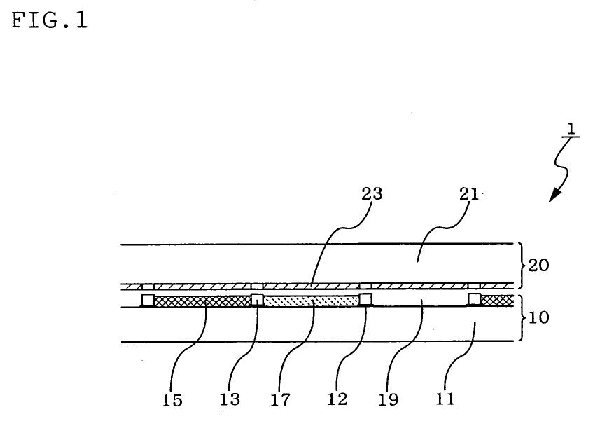

An emitting apparatus 1 shown in FIG. 1 was prepared by the following method.

Black matrices 12 were formed on a glass substrate 11 in the same manner as in Example 1, and a partition wall 13 was formed on each of the resulting black matrices 12. The composition obtained in Example 1 was applied to every third area partitioned by the partition wall 13. Then, the composition was irradiated with UV rays with a wavelength of 365 nm at 300 mJ to cure, thereby obtaining a red fluorescence conversion film 15.

Subsequently, the composition used in Example 2 was applied to a side of the red fluorescence conversion film 15 once. After evaporating the xylene, the composition was heated to 160° C. to cause the epoxy compound to react and cure, thereby obtaining a green fluorescence conversion film 17.

Finally, a photocurable ink 19 containing 27 wt % of a copolymer of methyl methacrylate and methacrylic acid (Mw=13,000), 19 wt % of pentaerythritol triacrylate, 0.4 wt % of Irgacure 907, and 53.6 wt % of 2-acetoxy-1-methoxypropane was applied to the entire surface of the substrate by spin coating. After drying the solvent at 120° C., the ink was irradiated with UV rays with a wavelength of 365 nm at 300 mJ to cure.

A fluorescence conversion substrate 10 was thus obtained.

On the substrate 21, electrodes (not shown), processed in the form of a matrix corresponding to the pitch of the partition walls 13 of the substrate 10, and a blue organic EL device 23 were formed, thereby obtaining an organic EL panel 20.

An emitting apparatus 1 was produced by adhering the organic EL panel 20 on the fluorescence conversion substrate 10. The resulting emitting apparatus 1 was caused to display an image. It was found that the apparatus displayed a full-color image.

### INDUSTRIAL APPLICABILITY

A color display using the color conversion substrate of the invention can be used in consumer or industrial displays, such as displays for portable display terminals, car-mounted displays such as displays for car navigation systems and instrumental panels, personal computers for office automation (OA), TVs, and displays for factory automation (FA). In particular, the color display of the invention can be employed for thin and flat monocolor, multicolor, or full-color displays.

What is claimed is:

1. A composition comprising:
(A) a fluorescent inorganic nanocrystal;
(B) a polyfunctional cross-linkable compound; and
(C) a polymerizable compound containing a group selected from a substituted or unsubstituted alkyl group having 4 to 20 carbon atoms, a substituted or unsubstituted alkylene group having 4 to 20 carbon atoms, a substituted or unsubstituted aryl group having 6 to 20 carbon atoms, or a substituted or unsubstituted arylene group having 6 to 20 carbon atoms.

2. The composition according to claim 1, wherein the total amount of the components (A) to (C) accounts for 40 wt % or more of the composition.

3. The composition according to claim 1 or 2, wherein the component (A) is contained in an amount of 1 to 45 wt %, the component (B) is contained in an amount of 1 to 40 wt %, and the component (C) is contained in an amount of 1 to 40 wt %.

4. The composition according to claim 1, wherein the polyfunctional cross-linkable compound (B) comprises at least one of a polyfunctional (meth)acrylate compound and a polyfunctional epoxy compound.

5. The composition according to claim 1, further comprising (D) a surface treatment agent for the fluorescent inorganic nanocrystal.

6. The composition according to claim 5, wherein a part or all of the surface treatment agent (D) for the fluorescent inorganic nanocrystal contains a polymerizable or cross-linkable substituent.

7. The composition according to claim 5, wherein the surface treatment agent (D) is contained in an amount of 20 wt % or less.

8. The composition according to claim 5, wherein the surface treatment agent (D) for the fluorescent inorganic nanocrystal contains at least one substituent selected from an amino group, a thiol group, a phosphoric ester group, a phosphonic acid group, a carboxyl group, an olefin group, a phosphine group, a phosphine oxide group, and an epoxy group.

9. The composition according to claim 1, further comprising a polymerization initiator.

10. The composition according to claim 1, having a content of a component with a boiling point of 200° C. or less of 0 to 60 wt %.

11. The composition according to claim 1, having a viscosity at 25° C. within the range of 0.001 to 0.020 Pa·s.

12. A cured product obtained by curing the composition according to claim 1.

13. A fluorescence conversion substrate comprising:
a substrate; and
a fluorescence conversion film formed of the cured product according to claim 12 and provided on the substrate.

14. The fluorescence conversion substrate according to claim 13, wherein partition walls are provided on the substrate, and the fluorescence conversion film is provided in an area partitioned by the partition walls.

15. A method for producing a fluorescence conversion substrate, comprising curing the composition according to claim 1 on a substrate to form a fluorescence conversion film.

16. The method for producing a fluorescence conversion substrate according to claim 15, wherein the composition according to claim 1 is applied on the substrate by a printing method, thereby forming the fluorescence conversion film.

17. The method for producing a fluorescence conversion substrate according to claim 16, wherein the printing method is an inkjet method or a nozzle jet method.

18. The method for producing a fluorescence conversion substrate according to claim 15, wherein the composition is applied to an area partitioned by the partition walls, thereby forming the fluorescence conversion film.

19. An emitting apparatus comprising:
an emitting device; and
the fluorescence conversion substrate according to claim 13.
